(19) United States
(12) Patent Application Publication
(10) Pub. No.: US 2014/0357185 A1
(43) Pub. Date: Dec. 4, 2014

(54) METHOD FOR INFORMATION PROCESSING AND ELECTRONIC DEVICE

(71) Applicants: Lenovo (Beijing) Co., Ltd., Beijing (CN); Beijing Lenovo Software Ltd., Beijing (CN)

(72) Inventor: Fanzhi Li, Beijing (CN)

(73) Assignees: Lenovo (Beijing) Co., Ltd., Beijing (CN); Beijing Lenovo Software Ltd., Beijing (CN)

(21) Appl. No.: 14/229,929

(22) Filed: Mar. 30, 2014

(30) Foreign Application Priority Data
Jun. 4, 2013 (CN) 201310219639.4

(51) Int. Cl. H04B 5/00

(52) U.S. Cl. CPC H04B 5/0031
USPC 455/41.1

(57) ABSTRACT

A method for information processing and an electronic device, wherein the method is applied to a first electronic device, and including: obtaining at least one piece of first parameter information relevant to a position relation between the first electronic device and a second electronic device in a process of a first mutual movement between the first and the second electronic device; and generating a first control instruction to be executed by the first electronic device based on the at least one piece of first parameter information, so that the first electronic device and the second electronic device are connected.

The present application claims priority to Chinese patent application No. 201310219639.4 titled “METHOD FOR INFORMATION PROCESSING AND ELECTRONIC DEVICE” and filed with the State Intellectual Property Office on Jun. 4, 2013, which is incorporated herein by reference in its entirety.

### TECHNICAL FIELD

The disclosure relates to the field of information processing technology, and particularly to a method for information processing and an electronic device.

### BACKGROUND

Along with the development of the software and hardware technology, there is an increasing demand for interactive operations between electronic devices. For example, in a case that a user desires to connect a Bluetooth earphone to a cell phone, during the connection process, operations need to be performed by the user back and forth between the Bluetooth earphone and the cell phone to establish such a connection. And take the case of performing synchronization between two cell phones for another example. In a case that two cell phones need to be connected, manual operations need to be performed on a first cell phone and a second cell phone respectively to achieve the synchronization between the first cell phone and the second cell phone. Hence, it has become more frequent and also increasingly necessary to perform interactive operations between electronic devices.

In the conventional technology, interactive operations between electronic devices are performed through a menu or by way of instruction input. That is, in the conventional technology, interactive operations between a first electronic device and a second electronic device is performed through an operation on a menu of the first electronic device and that of the second electronic device respectively, or through an instruction input operation on the first electronic device and the second electronic device respectively.

However, during the practice of the technical solution provided in the embodiments of the disclosure, it is found by inventors of the present application that the technology described above has at least the following technical problem.

Since in the conventional technology, interactive operations between electronic devices is performed through a menu or by way of instruction input, which requires a user's manual operations on different electronic devices back and forth and hence is inconvenient. For example, in a case that the user desires to perform on a first cell phone an synchronization operation with a second cell phone, the user first needs to perform a search operation through a menu of the first cell phone, or input an instruction to perform a search operation, and after a message sent by the first cell phone is received by the second cell phone, the user also needs to perform a confirmation operation on a menu of the second cell phone or input an instruction to perform the confirmation operation. Therefore, in the conventional technology, in a case an electronic device needs to communicate or transmit data with another electronic device, there is a technical problem that interactive operations between electronic devices are complex and hence inconvenient to be performed.

### SUMMARY

The embodiments of disclosure provide a method for information processing and an electronic device, so as to solve the technical problem of complex and inconvenient interactive operations between electronic devices that existed in the conventional technology in a case that an electronic device needs to communicate or transmit data with another electronic device.

In order to solve the above technical problem, embodiments of the disclosure on the one hand provide a method for information processing applied to a first electronic device. The method includes:

obtaining at least one piece of first parameter information relevant to a position relation between the first electronic device and a second electronic device in a process of a first mutual movement between the first and the second electronic device; and

generating a first control instruction to be executed by the first electronic device based on the at least one piece of first parameter information, so that the first electronic device and the second electronic device are connected;

further, the obtaining at least one piece of first parameter information relevant to a position relation between the first electronic device and a second electronic device in a process of a first mutual movement between the first and the second electronic device, includes:

obtaining at least one piece of first parameter information relevant to a position relation between the first and the second electronic device in a process that the first electronic device moves towards the second electronic device; or

obtaining at least one piece of first parameter information relevant to a position relation between the first and the second electronic device in a process that the second electronic device moves towards the first electronic device; or

obtaining at least one piece of first parameter information relevant to a position relation between the first and the second electronic device in a process that the first electronic device and the second electronic device simultaneously move towards each other;

further, the obtaining at least one piece of first parameter information relevant to a position relation between the first and the second electronic device includes:

obtaining, by a distance detection apparatus in the first electronic device, at least one first distance value between the first electronic device and the second electronic device; and/or

obtaining, by the distance detection apparatus, at least one first contact time length for indicating contact time and frequency between the first electronic device and the second electronic device;

further, the generating a first control instruction to be executed by the first electronic device based on the at least one piece of first parameter information, so that the first electronic device and the second electronic device are connected includes:

generating a first triggering control instruction to be executed by the first electronic device based on the at least one first distance value and a correspondence between a distance value and a control instruction, so that the first electronic device and the second electronic device are connected;

further, the generating a first control instruction to be executed by the first electronic device based on the at least one piece of first parameter information, so that the first electronic device and the second electronic device are connected includes:

generating a first triggering control instruction to be executed by the first electronic device based on the at least one first contact time length and a correspondence between the contact frequency plus the contact time and a control instruction, so that the first electronic device and the second electronic device are connected;

further, the obtaining at least one piece of first parameter information relevant to a position relation between the first and the second electronic device includes:

obtaining, by an electronic compass, at least one piece of first magnetic field change time information between the first and the second electronic device; and/or obtaining, by the electronic compass in the first electronic device, at least one piece of first magnetic field change frequency information between the first and the second electronic device;

further, the generating a first control instruction to be executed by the first electronic device based on the at least one piece of first parameter information, so that the first electronic device and the second electronic device are connected includes:

generating a first triggering control instruction to be executed by the first electronic device based on the at least one piece of first magnetic field change time information and a correspondence between magnetic field change time information and a control instruction, so that the first electronic device and the second electronic device are connected;

further, the generating a first control instruction to be executed by the first electronic device based on the at least one piece of first parameter information, so that the first electronic device and the second electronic device are connected includes:

generating a first triggering control instruction to be executed by the first electronic device based on the at least one piece of first magnetic field change frequency information and a correspondence between magnetic field change frequency information and a control instruction, so that the first electronic device and the second electronic device are connected.

After the generating a first control instruction to be executed by the first electronic device and/or the second electronic device based on the at least one piece of first parameter information, so that the first electronic device and the second electronic device are connected, the method further includes:

obtaining at least one piece of second parameter information relevant to a position relation between the first electronic device and the second electronic device in a process of a second mutual movement between the first and the second electronic device; and

generating a second control instruction different from the first control instruction to be executed by the first electronic device based on the at least one piece of second parameter information, so that the first electronic device and the second electronic device are disconnected.

The embodiments of the disclosure on the other hand provide an electronic device, and the electronic device includes:

an obtaining unit configured to obtain at least one piece of first parameter information relevant to a position relation between the electronic device and a second electronic device in a process of a first mutual movement between the electronic device and the second electronic device;

an instruction generating unit configured to generate a first control instruction based on the at least one piece of first parameter information; and

an instruction execution unit configured to execute the first control instruction, so that the electronic device and the second electronic device are connected;

further, the obtaining unit is configured to:

obtain at least one piece of first parameter information relevant to a position relation between the electronic device and the second electronic device in a process that the electronic device moves towards the second electronic device; or

obtain at least one piece of first parameter information relevant to a position relation between the electronic device and the second electronic device in a process that the second electronic device moves towards the electronic device; or

obtain at least one piece of first parameter information relevant to a position relation between the electronic device and the second electronic device in a process that the electronic device and the second electronic device simultaneously move towards each other;

further, the obtaining unit includes a distance detection apparatus configured to:

obtain at least one first distance value between the electronic device and the second electronic device; and/or

obtain at least one first contact time length for indicating contact time and frequency between the electronic device and the second electronic device;

further, the instruction generating unit is configured to:

generate a first triggering control instruction based on the at least one first distance value and a correspondence between a distance value and a control instruction;

further, the instruction generating unit is configured to:

generate a first triggering control instruction based on the at least one first contact time length and a correspondence between the contact frequency plus the contact time and the control instruction;

further, the obtaining unit includes an electronic compass configured to:

obtain at least one piece of first magnetic field change time information between the first electronic device and the second electronic device; and/or

obtain at least one piece of first magnetic field change frequency information between the first and the second electronic device;

further, the instruction generating unit is configured to:

generate a first triggering control instruction based on the at least one piece of first magnetic field change time information and a correspondence between magnetic field change time information and a control instruction;

further, the instruction generating unit is configured to:

generate a first triggering control instruction based on the at least one piece of first magnetic field change frequency information and a correspondence between magnetic field change frequency information and a control instruction;

further, the instruction execution unit is configured to:

execute the first triggering control instruction, so that the electronic device and the second electronic device are connected.

There are at least the following beneficial effects in one or more technical solutions of the disclosure.

Since the technical solution of the disclosure adopts the following method: obtaining at least one piece of first parameter information relevant to a position relation between the first electronic device and a second electronic device in a process of a first mutual movement between the first and the second electronic device; and generating a first control instruction to be executed by the first electronic device based on the at least one piece of first parameter information, so that the first electronic device and the second electronic device are connected. That is, the first electronic device obtains at least one piece of first parameter information relevant to a position relation between the first and the second electronic device to thereby automatically generate a control instruction, so that the first electronic device and the second electronic device are automatically connected. Therefore, the technical problem of complex and inconvenient interactive operations between electronic devices that existed in the conventional technology in a case that an electronic device needs to communicate or transmit data with another electronic device is effectively solved, and a technical effect of an automatic establishment of a connection and an effective reduction in the operation complexity during the performance of interactive operations between electronic devices is achieved.

### BRIEF DESCRIPTION OF THE DRAWINGS

FIG. 1 is a flowchart of a method for information processing according to an embodiment of the disclosure; and

FIG. 2 is a structural diagram of an electronic device according to an embodiment of the disclosure.

### DETAILED DESCRIPTION

Embodiments of the disclosure provide a method for information processing applied to a first electronic device, so as to effectively solve the technical problem of complex and inconvenient interactive operations between electronic devices that existed in the conventional technology in a case that an electronic device needs to communicate or transmit data with another electronic device, and achieve the technical effect of an automatic establishment of a connection and an effective reduction in the operation complexity during the performance of interactive operations between electronic devices.

In order to solve the above technical problem, the technical solution in the embodiments of the disclosure provides the following general idea.

In a process of a first mutual movement between the first electronic device and a second electronic device, at least one piece of first parameter information relevant to a position relation between the first and the second electronic device is obtained; and

a first control instruction to be executed by the first electronic device is generated based on the at least one piece of first parameter information, so that the first electronic device and the second electronic device are connected.

As can be seen that the technical solution of the disclosure adopts the following method: obtaining at least one piece of first parameter information relevant to a position relation between the first electronic device and a second electronic device in a process of a first mutual movement between the first and the second electronic device; and generating a first control instruction to be executed by the first electronic device based on the at least one piece of first parameter information, so that the first electronic device and the second electronic device are connected. That is, the first electronic device obtains at least one piece of first parameter information relevant to a position relation between the first and the second electronic device to thereby automatically generate a control instruction, so that the first electronic device and the second electronic device are automatically connected. Therefore, the technical solution effectively solves the technical problems of complex and inconvenient interactive operations between electronic devices that existed in the conventional technology in a case that an electronic device needs to communicate or transmit data with another electronic device, and achieves the technical effect of an automatic establishment of a connection and an effective reduction in the operation complexity during the performance of interactive operations between electronic devices.

The technical solutions described above will be described in detail hereunder in conjunction with accompanying drawings and specific embodiments for a better understanding.

### The First Embodiment

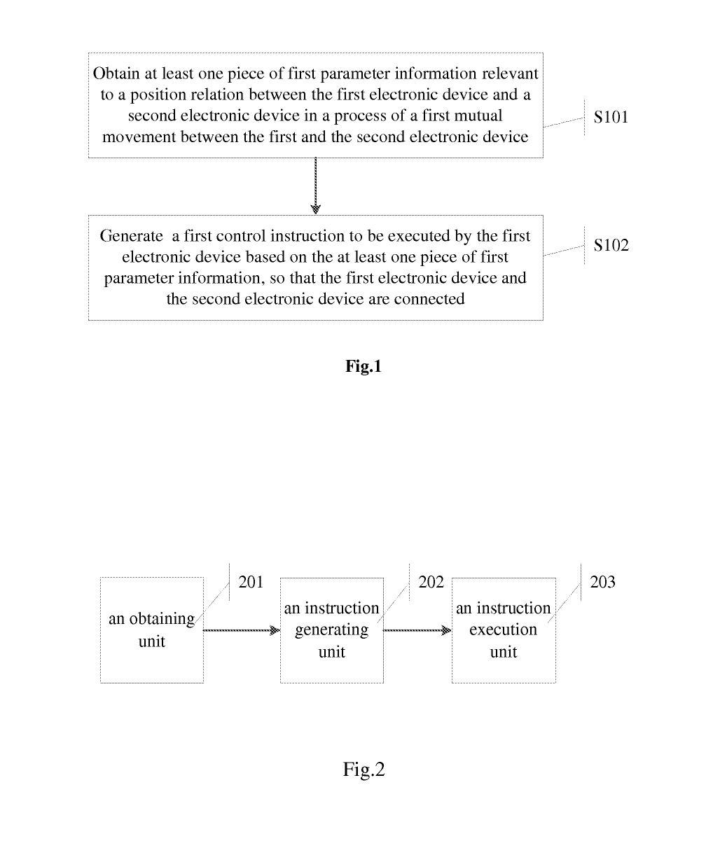

Referring to FIG. 1, the first embodiment provides a method for information processing applied to a first electronic device, the method includes:

step 101, obtaining at least one piece of first parameter information relevant to a position relation between the first electronic device and a second electronic device in a process of a first mutual movement between the first and the second electronic device; and

step 102, generating a first control instruction to be executed by the first electronic device based on the at least one piece of first parameter information, so that the first electronic device and the second electronic device are connected.

In the embodiment of the disclosure, the first electronic device may be an electronic device such as a mobile phone or a computer; and the second electronic device may be an electronic device such as a mobile phone or an earphone. Referring to FIG. 2, the first electronic device includes:

an obtaining unit 201 configured to obtain at least one piece of first parameter information relevant to a position relation between the first electronic device and a second electronic device in a process of a first mutual movement between the first electronic device and the second electronic device;

an instruction generating unit 202 configured to generate a first control instruction based on the at least one piece of first parameter information; and

an instruction execution unit 203 configured to execute the control instruction, so that the first electronic device and the second electronic device are connected.

Taking the first electronic device described above as an example, the implementing process of the method in the embodiment of the disclosure will be described in detail hereunder.

Step S101 includes:

obtaining at least one piece of first parameter information relevant to a position relation between the first and the second electronic device in a process that the first electronic device moves towards the second electronic device; or obtaining at least one piece of first parameter information relevant to a position relation between the first and the second electronic device in a process that the second electronic device moves towards the first electronic device; or obtaining at least one piece of first parameter information relevant to a position relation between the first and the second electronic device in a process that the first electronic device and the second electronic device simultaneously move towards each other, for example, in a case that the first electronic device is a first cell phone and the second electronic device is a second cell phone, obtaining at least one piece of first parameter information relevant to a position relation between the first cell phone and the second cell phone in a process that the first cell phone moves towards the second cell phone; or obtaining at least one piece of first parameter information relevant to a position relation between the first cell phone and the second cell phone in a process that the second cell phone moves toward the first cell phone; or obtaining at least one piece of first parameter information relevant to a position relation between the first cell phone and the second cell phone in a process that the first cell phone and the second cell phone simultaneously move towards each other;

preferably, in a case that the obtaining unit 201 is a distance detection apparatus, the implementing process of the obtaining at least one piece of first parameter information relevant to a position relation between the first and the second electronic device includes:

obtaining, by a distance detection apparatus in the first electronic device, at least one first distance value between the first and the second electronic device, for example, obtaining, by a distance detection apparatus in the first cell phone at least one first distance value between the first cell phone and the second cell phone in a process of a first mutual movement between the first cell phone and the second cell phone; and/or,

obtaining, by the distance detection apparatus, at least one first contact time length for indicating contact time and frequency between the first and the second electronic device, for example, obtaining, by the distance detection apparatus in the first cell phone at least one first contact time length for indicating contact time and frequency between the first cell phone and the second cell phone in a process of a first mutual movement between the first cell phone and the second cell phone, e.g., obtaining, by the distance detection apparatus, two contacts between the first cell phone and the second cell phone, the contact time for the first time as 3 seconds and the contact time for the second time as 2 seconds in a process of a mutual movement between the second cell phone and the first cell phone;

preferably, in a case that the obtaining unit 201 is an electronic compass, the implementing process of the obtaining at least one piece of first parameter information relevant to a position relation between the first and the second electronic device includes:

obtaining, by an electronic compass, at least one piece of first magnetic field change time information between the first and the second electronic device, for example, obtaining, by an electronic compass in the first cell phone, at least one piece of first magnetic field change time information between the first cell phone and the second cell phone in a process of a first mutual movement between the first cell phone and the second cell phone, e.g., in a case it is detected that the time point when there is magnetic field is 13:10:01, and it is detected that the time point till when there is no magnetic field is 13:10:21, the first magnetic field change time being 20 seconds; and/or

obtaining, by the electronic compass in the first electronic device, at least one piece of first magnetic field change frequency information between the first electronic device and the second electronic device, for example, obtaining, by the electronic compass in the first cell phone, at least one piece of first magnetic field change frequency information between the first cell phone and the second cell phone in a process of a first mutual movement between the first cell phone and the second cell phone; e.g., obtaining, by the electronic compass in the first cell phone, two magnetic field changes from no to yes status, that is, obtaining the first magnetic field change frequency as twice.

After step S101, the method in the embodiment of the disclosure goes to step S102, including:

generating a first triggering control instruction to be executed by the first electronic device based on the at least one first distance value and a correspondence between a first distance value and a control instruction, so that the first electronic device and the second electronic device are connected, the implementing process of which is: generating, by the instruction generating unit 202, a first triggering control instruction based on the at least one first distance value and a correspondence between a first distance value and a control instruction, and executing, by the instruction execution unit 203, the first triggering control instruction, so that the first electronic device and the second electronic device are connected;

further, generating a first triggering control instruction to be executed by the first electronic device based on the at least one first contact time length and a correspondence between the contact frequency plus the contact time and a control instruction, so that the first electronic device and the second electronic device are connected, the implementing process of which is: generating, by the instruction generating unit 202, a first triggering control instruction based on the at least one first contact time length and a correspondence between the contact frequency plus the contact time and a control instruction, and executing, by the instruction execution unit 203, the first triggering control instruction, so that the first electronic device and the second electronic device are connected;

preferably, generating a first triggering control instruction to be executed by the first electronic device based on the at least one piece of first magnetic field change time information and a correspondence between magnetic field change time information and a control instruction, so that the first electronic device and the second electronic device are connected, the implementing process of which is: generating, by the instruction generating unit 202, a first triggering control instruction based on the at least one piece of first magnetic field change time information and a correspondence between magnetic field change time information and a control instruction, and executing, by the instruction execution unit 203, the first triggering control instruction, so that the first electronic device and the second electronic device are connected;

further, generating a first triggering control instruction to be executed by the first electronic device based on the at least one piece of first magnetic field change frequency information and a correspondence between magnetic field change frequency information and a control instruction, so that the first electronic device and the second electronic device are connected, the implementing process of which is: generating, by the instruction generating unit 202 a first triggering control instruction based on the at least one piece of first magnetic field change frequency information and a correspondence between magnetic field change frequency information and a control instruction, and executing, by the instruction execution unit 203, the first triggering control instruction, so that the first electronic device and the second electronic device are connected;

after step S102, the method in the embodiment of the disclosure further includes:

obtaining at least one piece of second parameter information relevant to a position relation between the first and the second electronic device in a process of a second mutual movement between the first electronic device and the second electronic device; and generating a second control instruction different from the first control instruction to be executed by the first electronic device based on the at least one piece of second parameter information, so that the first electronic device and the second electronic device are disconnected, the implementing process of which is: obtaining, by the first cell phone, at least one piece of second parameter relevant to a position relation between the first cell phone and the second cell phone in a process of a second mutual movement between the first and the second cell phone, and generating a second control instruction different from the first control instruction to be executed by the first cell phone based on the at least one piece of second parameter information, so that the first cell phone and the second cell phone are disconnected, whose detailed implementing process is similar to the process of establishing a connection between the first cell phone and the second cell phone, which is not repeated herein.

The technical solution provided in the disclosure has at least the following beneficial effects.

Since the technical solution of the disclosure includes the following method: obtaining at least one piece of first parameter information relevant to a position relation between the first electronic device and a second electronic device in a process of a first mutual movement between the first and the second electronic device; and generating a first control instruction to be executed by the first electronic device based on the at least one piece of first parameter information, so that the first electronic device and the second electronic device are connected. That is, the first electronic device obtains at least one piece of first parameter information relevant to a position relation between the first and the second electronic device, and generates automatically a control instruction, so that the first electronic device and the second electronic device are connected. Therefore, the technical solution effectively solves the technical problems of complex and inconvenient interactive operations between electronic devices that existed in the conventional technology in a case that an electronic device needs to communicate or transmit data with another electronic device, and achieves the technical effect of an automatic establishment of a connection and an effective reduction in the operation complexity during the performance of interactive operations between electronic devices.

### The Second Embodiment

An embodiment of the disclosure also provides an electronic device, and the electronic device is a first electronic device. Reference is made to FIG. 2, the first electronic device includes:

an obtaining unit 201 configured to obtain at least one piece of first parameter information relevant to a position relation between the first electronic device and a second electronic device in a process of a first mutual movement between the first and the second electronic device;

an instruction generating unit 202 configured to generate a first control instruction based on the at least one piece of first parameter information; and

an instruction execution unit 203 configured to execute the first control instruction, so that the first electronic device and the second electronic device are connected.

Functions of respective parts of the electronic device in the embodiment of the disclosure are described in detail in conjunction with FIG. 2 hereunder.

The obtaining unit 201 is configured to: obtain at least one piece of first parameter information relevant to a position relation between the first electronic device and the second electronic device in a process that the first electronic device moves towards the second electronic device; or obtain at least one piece of first parameter information relevant to a position relation between the first electronic device and the second electronic device in a process that the second electronic device moves towards the first electronic device; or obtain at least one piece of first parameter information relevant to a position relation between the first electronic device and the second electronic device in a process that the first electronic device and the second electronic device simultaneously move towards each other; for example, in a process of a mutual movement between a first cell phone and a second cell phone, which may be, the first cell phone moving towards the second cell phone, or the second cell phone moving towards the first cell phone, or the first cell phone and the second cell phone simultaneously moving towards each other, the obtaining unit 201 in the first cell phone obtaining at least one piece of first parameter information relevant to a position relation between the first and the second cell phone in the process of a mutual movement.

Further, the obtaining unit 201 may include a distance detection apparatus configured to obtain at least one first distance value between the first electronic device and the second electronic device; and/or configured to obtain at least one first contact time length for indicating contact time and frequency between the first electronic device and the second electronic device.

Further, the obtaining unit 201 may includes an electronic compass, configured to obtain at least one piece of first magnetic field change time information between the first and the second electronic device; and/or obtain at least one piece of first magnetic field change frequency information between the first and the second electronic device.

The instruction generating unit 202 is configured to: generate a first triggering control instruction based on the at least one first distance value and a correspondence between a distance value and a control instruction; or generate a first triggering control instruction based on the at least one first contact time length and a correspondence between the contact frequency plus the contact time and the control instruction.

The instruction generating unit 202 is further configured to: generate a first triggering control instruction based on the at least one piece of first magnetic field change time information and a correspondence between magnetic field change time information and a control instruction; or generate a first triggering control instruction based on the at least one piece of first magnetic field change frequency information and a correspondence between magnetic field change frequency information and a control instruction.

The instruction execution unit 203 is configured to execute the first triggering control instruction, so that the first electronic device and the second electronic device are connected.

In order to make those skilled in the art better understand the electronic device in the embodiment of the disclosure, a working process of the electronic device will be described hereinafter.

In a case that a triggering operation is performed between a first cell phone and a second cell phone, or a triggering operation may be performed between a first cell phone and a first earphone, in the implementing process, taking a case that a triggering operation is performed between a first cell phone and a second cell phone for an example, the process is described as follows.

Firstly, the obtaining unit 201 obtaining at least one piece of first parameter information relevant to a position relation between the first cell phone and the second cell phone in a process that the first cell phone moves towards the second cell phone; or the obtaining unit 201 obtaining at least one piece of first parameter information relevant to a position relation between the first cell phone and the second cell phone in a process that the second cell phone moves towards the first cell phone; or the obtaining unit 201 obtaining at least one piece of first parameter information relevant to a position relation between the first cell phone and the second cell phone in a process that the first cell phone and the second cell phone simultaneously move towards each other,

further, in a case the obtaining unit 201 includes a distance detection apparatus, the distance detection apparatus obtaining at least one first distance value between the first cell phone and the second cell phone; or the distance detection apparatus obtaining at least one first contact time length for indicating contact time and frequency between the first cell phone and the second cell phone, for example, the distance detection apparatus obtaining a first distance value of 12 cm between the first cell phone and the second cell phone in a process of a mutual movement between the first cell phone and the second cell phone; or the distance detection apparatus obtaining two contacts with the second cell phone, the contact time for the first time as 3 seconds and the contact time for the second time as 2 seconds in a process of a mutual movement between the first cell phone and the second cell phone;

further, in a case that the obtaining unit 201 includes an electronic compass, the electronic compass is configured to obtain at least one piece of first magnetic field change time information between the first cell phone and the second cell phone, for example, the electronic compass obtaining at least one piece of first magnetic field change time information between the first cell phone and the second cell phone in a process of a first mutual movement between the first cell phone and the second cell phone, e.g., in a case it is detected that the time point when there is magnetic field is 13:10:01, and in a case it is detected that the time point till when there is no magnetic field is 13:10:21, the first magnetic field change time being 20 seconds; or the electronic compass is configured to obtain at least one piece of magnetic field change frequency information between the first cell phone and the second cell phone, for example, the electronic compass obtaining at least one piece of first magnetic field change frequency information between the first cell phone and the second cell phone in a process of a first mutual movement between the first cell phone and the second cell phone, e.g., the electronic compass obtaining magnetic field change information from no to yes status as twice, i.e. obtaining a first magnetic field change frequency as twice.

After that, the instruction generating unit 202 is configured to generate a first triggering control instruction based on the at least one first distance value and a correspondence between a distance value and a control instruction; or generate a first triggering control instruction based on the at least one first contact time length and a correspondence between the contact frequency plus the contact time and a control instruction, for example, the instruction generating unit 202 generating a first triggering control instruction, which is to trigger the first cell phone to perform a handshake operation with the second cell phone, based on the first distance value of 12 cm and a correspondence between a distance value and a control instruction; or the instruction generating unit 202 generating a first triggering control instruction, which is to trigger the first cell phone to perform a synchronization operation with the second cell phone, based on first contact time length, which is, the first cell phone contacting with the second cell phone twice, the contact time for the first time as 3 seconds and the contact time for the second time as 2 seconds, and a correspondence between the contact frequency plus the contact time and a control instruction;

further, the instruction generating unit 202 is configured to generate a first triggering control instruction based on the at least one magnetic field change time information and a correspondence between magnetic field change time information and a control instruction; or generate a first triggering control instruction based on the at least one piece of first magnetic field change frequency information and a correspondence between magnetic field change frequency information and a control instruction, for example, the instruction generating unit 202 generating a first triggering control instruction, which is to trigger the first cell phone to perform a handshake operation with the second cell phone, based on the first magnetic field change time of 20 seconds and a correspondence between magnetic field change time information and a control instruction; or, the instruction generating unit 202 generating a first triggering control instruction, which is to trigger the first cell phone to perform a synchronization operation with the second cell phone, based on the first magnetic change frequency of twice and a correspondence between magnetic change frequency information and a control instruction.

And lastly, the instruction execution unit 203 is configured to execute the first triggering control instruction, so that the first cell phone and the second cell phone are connected.

Further, the obtaining unit 201 is configured to obtain at least one piece of second parameter information relevant to a position relation between the first cell phone and the second cell phone in a process of a second mutual movement between the first and the second cell phone; and the instruction generating unit 202 is configured to generate a second control instruction different form the first control instruction to be executed by the first cell phone, based on the at least one piece of second parameter information, so that the first cell phone and the second cell phone are disconnected, whose detailed implementing process is similar to the process of establishing a connection between the first cell phone and the second cell phone, which is not repeated herein.

In order to make those skilled in the art better understand the technical solution provided in the embodiment of the disclosure, the solution provided in the embodiment of the disclosure will be described hereinafter in detail from a perspective of a user.

Supposing that a user A has a smart phone and a tablet, and the user desires to transmit a first music file in a smart phone to a tablet. According to the solution provided in the embodiment of the disclosure, the whole implementing process is as follows.

Firstly, the obtaining unit 201 in the smart phone obtaining at least one piece of first parameter information relevant to a position relation between the smart phone and the tablet in a process that the smart phone moves towards the tablet, or the obtaining unit 201 obtaining at least one piece of first parameter information relevant to a position relation between the smart phone and the tablet in a process that the tablet moves towards the smart phone; or the obtaining unit 201 obtaining at least one piece of first parameter information relevant to a position relation between the smart phone and the tablet in a process that the smart phone and the tablet simultaneously move towards each other,

further, in a case the obtaining unit 201 includes a distance detection apparatus, the distance detection apparatus obtaining at least one first distance value between the smart phone and the tablet; or the distance detection apparatus obtaining at least one first contact time length for indicating contact time and frequency between the smart phone and the tablet;

further, in a case that the obtaining unit 201 includes an electronic compass, the electronic compass is configured to obtain at least one piece of first magnetic field change time information between the smart phone and the tablet; or the electronic compass is configured to obtain at least one piece of first magnetic field change frequency information between the smart phone and the tablet;

during an implementation process of the present embodiment, the electronic compass obtaining at least one piece of first magnetic field change frequency information between the smart phone and the tablet in a process of a first mutual movement between the smart phone and the tablet, e.g., the electronic compass obtaining the magnetic field change information from no to yes status as twice, i.e. obtaining the first magnetic field change frequency as twice.

After that, the instruction generating unit 202 is configured to generate a first triggering control instruction based on the at least one first distance value and a correspondence between a distance value and a control instruction; or generate a first triggering control instruction based on the at least one first contact time length and a correspondence between the contact frequency plus the contact time and a control instruction;

further, the instruction generating unit 203 is configured to generate a first triggering control instruction based on the at least one piece of first magnetic field change time information and a correspondence between magnetic change time information and a control instruction; or generate a first triggering control instruction based on the at least one piece of first magnetic change frequency information and a correspondence between magnetic change frequency and a control instruction;

during an implementing process of the present embodiment, the instruction generating unit 202 generating a first triggering control instruction, which is to trigger the smart phone to transmit data to the tablet, based on the first magnetic field change frequency of twice, and a correspondence between magnetic field change frequency information and a control instruction.

And lastly, the instruction execution unit 203 is configured to execute the first control instruction, i.e., to execute the operation of triggering the smart phone to transmit data to the tablet, so as to make the smart phone to transmit the first music file to the tablet, during the particular transmission process of which, data may be transmitted following the Bluetooth transmission protocol, the Zigbee wireless transmission protocol, or other wireless transmission protocol like the 802.11, etc;

further, after the transmission of the first music file is finished, the obtaining unit 201 obtaining at least one piece of second parameter information relevant to a position relation between the smart phone and the tablet in a process of a second mutual movement between the smart phone and the tablet; and the instruction generating unit 202 generating a second control instruction different form the first control instruction to be executed by the smart phone based on at least one piece of second parameter information, so that the smart phone and the tablet are disconnected, whose detailed implementing process is similar to a process of establishing a connection between the smart phone and the tablet, which is not repeated here.

There are at least the following beneficial effects in the technical solution provided in the above embodiment of the disclosure. Since the technical solution of the disclosure adopts the following method: obtaining at least one piece of first parameter information relevant to a position relation between the first electronic device and a second electronic device in a process of a first mutual movement between the first and the second electronic device; and generating a first control instruction to be executed by the first electronic device based on the at least one piece of first parameter information, so that the first electronic device and the second electronic device are connected. That is, the first electronic device obtains at least one piece of first parameter information relevant to a position relation between the first and the second electronic device to thereby automatically generate a control instruction, so that the first electronic device and the second electronic device are automatically connected. Therefore, the technical solution effectively solves the technical problems of complex and inconvenient interactive operations between electronic devices that existed in the conventional technology in a case that an electronic device needs to communicate or transmit data with another electronic device, and achieves the technical effect of an automatic establishment of a connection and an effective reduction in the operation complexity during the performance of interactive operations between electronic devices.

Although the preferred embodiments of the disclosure have been described, those skilled in the art can make additional variations and modifications to these embodiments once knowing the basic creative concept of the disclosure. Therefore, the appended claims are intended to be construed as including the preferred embodiments and all changes and modifications that fall within the scope of the disclosure.

Obviously, those skilled in the art can make various modifications and variations to the disclosure without departing from the spirit and scope of the disclosure. Thus, if these modifications and variations of the disclosure belong to the scope defined by the claims of the disclosure and equivalents thereof, the disclosure is also intended to include these modifications and variations.

1. A method for information processing applied to a first electronic device, comprising:
obtaining at least one piece of first parameter information relevant to a position relation between the first electronic device and a second electronic device in a process of a first mutual movement between the first and the second electronic device; and
generating a first control instruction to be executed by the first electronic device based on the at least one piece of first parameter information, so that the first electronic device and the second electronic device are connected.

2. The method according to claim 1, wherein the obtaining at least one piece of first parameter information relevant to a position relation between the first electronic device and a second electronic device in a process of a first mutual movement between the first and the second electronic device comprises:
obtaining at least one piece of first parameter information relevant to a position relation between the first and the second electronic device in a process that the first electronic device moves towards the second electronic device; or
obtaining at least one piece of first parameter information relevant to a position relation between the first and the second electronic device in a process that the second electronic device moves towards the first electronic device; or
obtaining at least one piece of first parameter information relevant to a position relation between the first and the second electronic device in a process that the first electronic device and the second electronic device simultaneously move towards each other.

3. The method according to claim 2, wherein the obtaining at least one piece of first parameter information relevant to a position relation between the first and the second electronic device comprises:
obtaining, by a distance detection apparatus in the first electronic device, at least one first distance value between the first and the second electronic device; and/or
obtaining, by the distance detection apparatus, at least one first contact time length for indicating contact time and frequency between the first and the second electronic device.

4. The method according to claim 3, wherein the generating a first control instruction to be executed by the first electronic device based on the at least one piece of first parameter information, so that the first electronic device and the second electronic device are connected comprises:
generating a first triggering control instruction to be executed by the first electronic device based on the at least one first distance value and a correspondence between a distance value and a control instruction, so that the first electronic device and the second electronic device are connected.

5. The method according to claim 3, wherein the generating a first control instruction to be executed by the first electronic device based on the at least one piece of first parameter information, so that the first electronic device and the second electronic device are connected comprises:
generating a first triggering control instruction to be executed by the first electronic device based on the at least one first contact time length and a correspondence between the contact frequency plus the contact time and a control instruction, so that the first electronic device and the second electronic device are connected.

6. The method according to claim 2, wherein the obtaining at least one piece of first parameter information relevant to a position relation between the first and the second electronic device comprises:
obtaining, by an electronic compass, at least one piece of first magnetic field change time information between the first and the second electronic device; and/or
obtaining, by the electronic compass in the first electronic device, at least one piece of first magnetic field change frequency information between the first and the second electronic device.

7. The method according to claim 6, wherein the generating a first control instruction to be executed by the first electronic device based on the at least one piece of first parameter information, so that the first electronic device and the second electronic device are connected comprises:
generating a first triggering control instruction to be executed by the first electronic device based on the at least one piece of first magnetic field change time information and a correspondence between magnetic field change time information and a control instruction, so that the first electronic device and the second electronic device are connected.

8. The method according to claim 6, wherein the generating a first control instruction to be executed by the first electronic device based on the at least one piece of first parameter information, so that the first electronic device and the second electronic device are connected comprises:
generating a first triggering control instruction to be executed by the first electronic device based on the at least one piece of first magnetic field change frequency information and a correspondence between magnetic field change frequency information and a control instruction, so that the first electronic device and the second electronic device are connected.

9. The method according to claim 1, wherein after the generating a first control instruction to be executed by the first electronic device and/or the second electronic device based on the at least one piece of first parameter information, so that the first electronic device and the second electronic device are connected, the method further comprises:
obtaining at least one piece of second parameter information relevant to a position relation between the first and the second electronic device in a process of a second mutual movement between the first electronic device and the second electronic device; and
generating a second control instruction different from the first control instruction to be executed by the first electronic device based on the at least one piece of second parameter information, so that the first electronic device and the second electronic device are disconnected.

10. An electronic device, comprising:
an obtaining unit configured to obtain at least one piece of first parameter information relevant to a position relation between the electronic device and a second electronic device in a process of a first mutual movement between the electronic device and the second electronic device;
an instruction generating unit configured to generate a first control instruction based on the at least one piece of first parameter information; and
an instruction execution unit configured to execute the first control instruction, so that the electronic device and the second electronic device are connected.

11. The electronic device according to claim 10, wherein the obtaining unit is configured to:
obtain at least one piece of first parameter information relevant to a position relation between the electronic device and the second electronic device in a process that the electronic device moves towards the second electronic device; or
obtain at least one piece of first parameter information relevant to a position relation between the electronic device and the second electronic device in a process that the second electronic device moves towards the electronic device; or
obtain at least one piece of first parameter information relevant to a position relation between the electronic device and the second electronic device in a process that the electronic device and the second electronic device simultaneously move towards each other.

12. The electronic device according to claim 11, wherein the obtaining unit comprises a distance detection apparatus configured to:
obtain at least one first distance value between the electronic device and the second electronic device; and/or
obtain at least one first contact time length for indicating contact time and frequency between the electronic device and the second electronic device.

13. The electronic device according to claim 12, wherein the instruction generating unit is configured to:
generate a first triggering control instruction based on the at least one first distance value and a correspondence between a distance value and a control instruction.

14. The electronic device according to claim 12, wherein the instruction generating unit is configured to:
generate a first triggering control instruction based on the at least one first contact time length and a correspondence between the contact frequency plus the contact time and the control instruction.

15. The electronic device according to claim 11, wherein the obtaining unit comprises an electronic compass configured to:
obtain at least one piece of first magnetic field change time information between the first and the second electronic device; and/or
obtain at least one piece of first magnetic field change frequency information between the first and the second electronic device.

16. The electronic device according to claim 15, wherein the instruction generating unit is configured to:
generate a first triggering control instruction based on the at least one piece of first magnetic field change time information and a correspondence between magnetic field change time information and a control instruction.

17. The electronic device according to claim 15, wherein the instruction generating unit is configured to:
generate a first triggering control instruction based on the at least one piece of first magnetic field change frequency information and a correspondence between magnetic field change frequency information and a control instruction.

18. The electronic device according to claim 13, wherein the instruction execution unit is configured to:
execute the first triggering control instruction, so that the first electronic device and the second electronic device are connected.
